(19) United States
(12) Patent Application Publication
(10) Pub. No.: US 2006/0250234 A1
(43) Pub. Date: Nov. 9, 2006

(54) Medical system for radio-based remote monitoring of the location of a patient

(76) Inventor: Michael Maschke, Lonnerstadt (DE)

Correspondence Address: SCHIFF HARDIN, LLP;PATENT DEPARTMENT, 6600 SEARS TOWER, CHICAGO, IL, 60606-6473, US

(21) Appl. No.: 11/410,361

(22) Filed: Apr. 25, 2006

(30) Foreign Application Priority Data
Apr. 25, 2005 (DE) 10 2005 019 111.8

(51) Int. Cl. G08B 1/08

(52) U.S. Cl. 340/539.13; 340/539.23

(57) ABSTRACT

For simple and reliable radio-based remote monitoring of the location of a patient without limiting his or her freedom of movement, two different locating technologies are provided for the determination of the patient's location, inside and outside of the building. For this purpose, the system has first transmission and/or receiving units distributed inside the building and second transmission and/or receiving units distributed outside the building, which at least temporarily establish a building-internal radio communication or building-external radio communication, respectively, with a third transmission and/or receiving unit in order to produce at least one location-relevant signal. A control unit has access to the building-internal radio communication and the building-external radio communication and determines the location of the patient based on the at least one location-relevant radio signal. A central monitoring unit displays this determined location.

### BACKGROUND OF THE INVENTION

1. Field of the Invention

The present invention relates to a medical system for radio-based remote monitoring of the location of a patient.

2. Description of the Prior Art

A patient must often be monitored due to his or her state of health, so that the patient's freedom of movement is limited. Extending the freedom of movement of the patient may have the consequence that in the case of an emergency, the current location of the patient might be unknown and therefore immediate medical assistance could not be provided.

A system for the recording and evaluation of the state of a person in an apartment is known from DE 196 37 383 A1, wherein a control unit is carried on the body of a person, which can also provide data corresponding to the current location of the person within an apartment. This data can be transmitted wirelessly from a transmitter at the control unit to a receiver at a central station. To locate the person, small transmitters are installed in significant places in the apartment that transmit signals that are unique for the each location that are received, when the person comes into the proximity thereof, by a receiver contained in the control unit, and are evaluated by the control unit.

### SUMMARY OF THE INVENTION

An object of the invention is to provide a medical system that enables reliable remote monitoring of the location of a patient in a simple way without limiting the patient's freedom of movement.

The above object is achieved in accordance with the present invention by a medical system for radio-based remote monitoring of the location of a patient, without limiting the patient's freedom of movement, wherein two different locating technologies are employed for the determination of the patient's location, one locating system for determining the patient's location within a building, and another locating system for determining the patient's location outside of the building. The system has first transmission and/or receiving units distributed inside the building and second transmission and/or receiving units distributed outside of the building. The units can respectively (temporarily) establish a building-internal radio communication or a building-external radio communication with a third transmission and/or receiving unit in order to produce at least one location relevant signal. A control unit has access to the building-internal radio communication and the building-external radio communication and determines the location of the patient based on the at least one location-relevant signal. A central monitoring unit displays the determined location.

By means of radio-based determination of the location of the patient either within or outside the building, the patient's freedom of movement can be reliable beyond the interior of the building while still providing the reliable continuous monitoring necessary for quick medical emergency assistance. The patient's current location can be determined inside or outside the building particularly reliably and exactly by the control unit due to the fact that a location-relevant radio signal is provided on the building-internal or building-external radio communication between the first or second transmission and/or receiver unit and the third transmission and/or receiver station assigned to the patient. The location determined by the control unit is displayed on a central monitoring unit for particularly reliable remote monitoring.

Two different locating technologies for the determination of the location, respectively active (sensitive) within the building and outside the building, make it possible to take the different requirements into consideration, particularly regarding the spatial resolution of the location areas and the different signal strengths of the radio signal, for the building-internal and the building-external radio communications. For determination of the patient's location inside the building, a first locating technology is used that has a high locational resolution, e.g. with an accuracy of a few meters, so that exact determination of the floor and/or room in which the patient is located is possible. Moreover, depending on the embodiment, the radio-shielding effect of the interior and exterior walls of the building is taken into consideration. For determination of the patient's location outside the building, a second locating technology is used that which has a long range, e.g. with a sensitivity over at least several square kilometers, so that the patient is permitted a great deal of freedom of movement.

One easy-to-use first locating technology suitable for determination of the location within the building, which in many cases can make use of an existing infrastructure of transmitters and/or receivers at low cost, is the familiar technology “Wireless Local Area Network”, or WLAN technology, In one embodiment of the invention, determination of the location within the building is based on WLAN technology that the first transmission and/or receiving stations each have a WLAN base station and the third transmission and/or receiving station has a WLAN terminal.

A determination of the current location within the building with a particularly high location resolution based on WLAN technology is made possible using triangulation based on measurements by at least three of the WLAN base stations of the signal quality and/or signal strength of at least one radio signal transmitted by the WLAN terminal. Such a triangulation is known from an article by P. Bahl and V. N. Padmanabhan entitled “RADAR: An I-Building RF-based User Location and Tracking System” (Proc. IEEE Infocom 2000, Tel Aviv, Israel, March 2000).

Another first locating technology that enables the particularly reliable determination of current location within the building is the known technology “Radio Frequency Identification”, or RFID technology and another embodiment of the invention, determination of the location within the building is based on RFID technology such that the first receiving stations each have an RFID reading device and the third transmitting station has an RFID transponder. If the patient and his or her RFID transponder enter the detection area of an RFID reader, so it can read the RFID transponder based on radio, then the location of the patient is determined to be within this detection area. It is useful to locate the RFID readers in the doors of the rooms of the building and/or in the halls of the building.

One easy-to-use second locating technology suitable for determination of the location outside the building, which can make use of a widely available, existing, very dense infrastructure of transmitters and/or receivers in a low-cost manner, is the known digital mobile radio technology, e.g. the GSM or UMTS radio network in Europe or the CMDA2000 radio network in the US. In another embodiment of the invention, determination of the location outside the building is based on digital mobile radio technology such that the first transmission and receiving stations each have a mobile radio base station and the third transmission and receiving station has a mobile radio terminal.

A determination of the current location with a particularly high location resolution, based on mobile radio technology is made possible using triangulation based on the signal travel time measured by at least three of the mobile radio base stations of at least one radio signal transmitted by the mobile radio terminal; such a triangulation is also known from the article by P. Bahl and V. N. Padmanabhan (“RADAR: An I-Building RF-based User Location and Tracking System” (Proc. IEEE Infocom 2000, Tel Aviv, Israel, March 2000)) and is described there under the heading “time difference of arrival (TDOA)”. Another process for location based on signal travel times is generally known under the term “Enhanced Observed Time Difference”, or E-OTD.

Another second locating technology allowing the determination of the current location outside the building with a particularly high location resolution is the known technology referred to as a “Global Positioning System” or GPS. In another according to one embodiment of the invention, the determination of the location outside the building is based on a GPS type of technology such that the first transmission station has a satellite transmitter of the GPS type and the third receiving station has a satellite receiver of the GPS type. Alternatively, to GPS, comparable technologies may be used, such as the satellite-supported system “Galileo.”

### DESCRIPTION OF THE DRAWINGS

FIG. 1 shows a building with transmission and receiving stations for determination of the location of a patient based on WLAN technology inside the building and based on mobile radio technology outside the building, as well as with an RFID reader for detection of the patient's departure from the building, with the patient being located inside the building.

FIG. 2 shows the building as in FIG. 1, but with the patient located outside the building;

FIG. 3 shows an enlarged representation of a third transmission and receiving station assigned to the patient with a WLAN terminal, a mobile radio terminal, an RFID transponder, and a sensor for detection of the patient's heart rate.

FIG. 4 shows the building as in FIG. 1 with transmission and/or receiving stations for determination of the patient's location based on RFID technology inside the building and based on GPS technology outside the building, with the patient inside the building.

FIG. 5 shows the building as in FIG. 4, with the patient located outside the building.

FIG. 6 shows an enlarged representation of a third transmitting and receiving station assigned to the patient, with a GPS receiver, the RFID transponder, and a second control unit.

FIG. 7 shows a monitor image generated by a central monitoring unit with a representation of the building for display of the location of the patient within the building.

FIG. 8 shows a monitor image as in FIG. 7 with a map view of the surroundings of the building for display of the location of a patient located in the surroundings outside the building.

### DESCRIPTION OF THE PREFERRED EMBODIMENTS

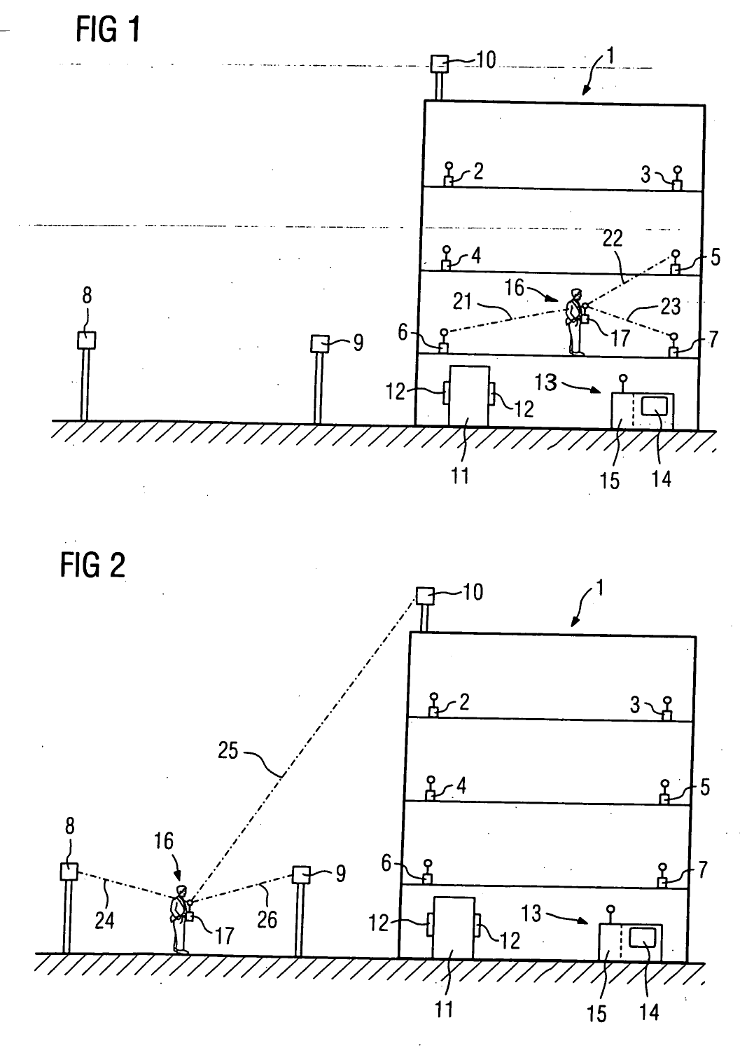

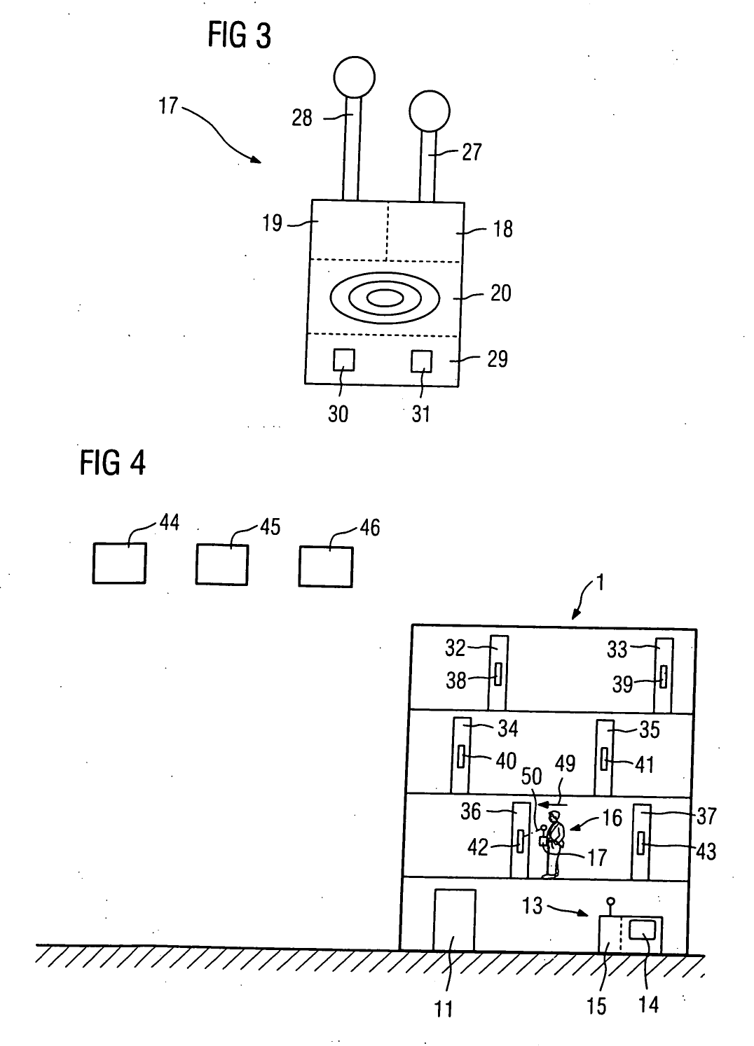

FIG. 1 and FIG. 2 each show a side view of a building 1, first transmission and receiving stations distributed within building 1 in the form of WLAN base stations 2 through 7, second transmission and receiving stations distributed outside building 1 in the form of mobile radio base stations 8 through 10, an RFID reader 12 located at an entry area 11 to the building 1, a central monitoring unit 13 located in building 1 with a monitor 14 and with an integrated control unit 15, and a patient 16 with an associated, symbolically represented, third transmission and receiving station 17 which has a WLAN terminal 18, a mobile radio terminal 19, and an RFID transponder 20. Details as to the structure of the third transmission and receiving station 17 can be seen in an enlarged representation in FIG. 3.

In FIG. 1, the patient 16 is assumed to be inside building 1. Between the third transmission and receiving station 17 and three WLAN base stations 5 through 7 closest to the patient 16, there is a building-internal, WLAN-based radio connection 21 through 23. The control unit 15 is provided for the determination of the current location of the patient 16 using a triangulation based on a signal strength measured by each of the three WLAN base stations 5 through 7 of a radio signal transmitted by WLAN terminal 18 of patient 16 on radio connection 21 through 23. For the WLAN-based radio connection 21 through 23, it is reasonable to provide an encryption, for instance of the type of the so-called “Wired Equivalent Privacy”, or WEP.

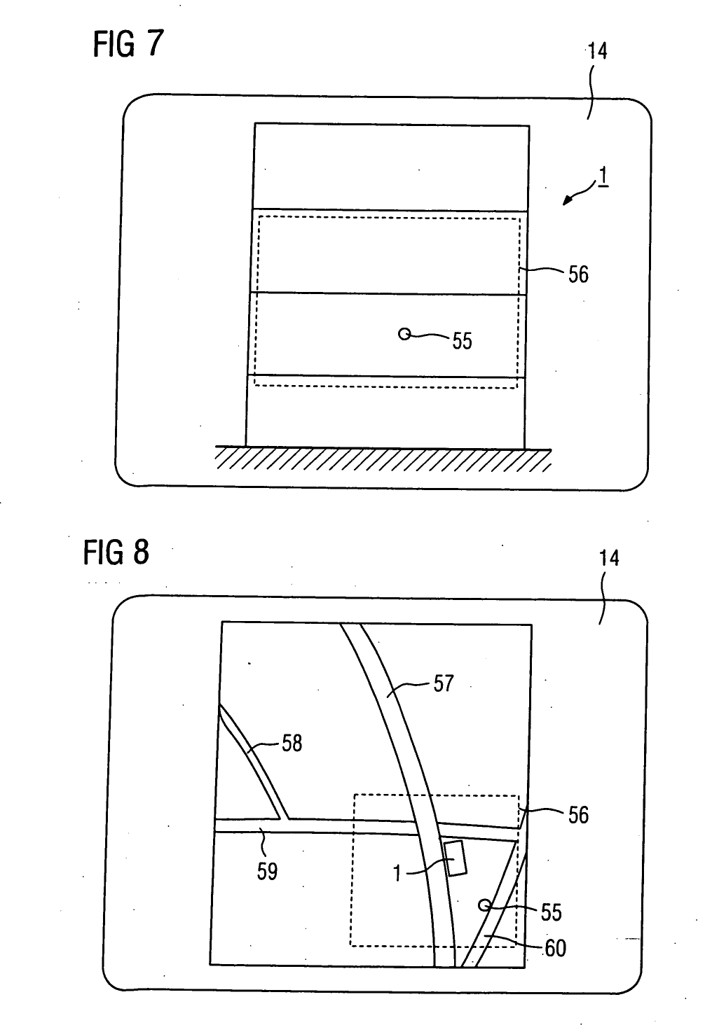

Further details for the determination and further processing of the location of patient 16 will be described in connection with FIG. 2 and with FIGS. 7 and 8.

To ensure a particularly reliable continuous monitoring of patient 16 both inside and outside of building 1, there is an automatic switchover between the building-internal WLAN-based radio connection 21 through 23 and a building-external mobile radio-based radio connection 24-26, in the case of entry and exit from the building 1 through the entry area 11, depending on the receipt, by RFID reader 12 located in entry area 11, of the RFID transponder 20 integrated into the third transmission and receiving unit 16. The entry area 11 can—as in this exemplary embodiment—be a door or an entry hallway or an entry room.

The system can also be operated without automatic switching based on the RFID reader 12. In such an embodiment, a continuous monitoring of patient 16 both inside and outside building 1 can be particularly easily implemented by the determination of the location based on building-external radio links 24 through 26 being performed only after an unsuccessful attempt to determine location based on the building-internal radio communications 21-23. Since the building 1 and its exterior wall typically shield the WLAN base stations 2 through 7 from a radio connection penetrating the exterior wall to the WLAN terminal 18 located outside the building 1, this results during use of the system in the current location inside building 1, as shown in FIG. 1, being determined based on the building-internal radio communication 21 through 23 and outside building 1, as shown in FIG. 2, being determined based on the building-external radio communication 24 through 26.

A continual monitoring is enabled without the RFID reader 12 in a simple manner by the fact that automatic switching between the building-internal radio communication 21 through 23 and the building-external radio communication 24 through 26 can be performed by utilization of the momentarily higher signal quality and/or signal strength. In this embodiment as well, the location of the patient 16 is determined, due to the shielding effect of the exterior wall of building 1, primarily based on the building-internal radio communication 21 through 23 within the building 1 and primarily based on the building-external radio communication 24 through 26 outside building 1. Depending on the strength of the shielding effect of the exterior wall, in the immediate vicinity of building 1 both of the variants of determination described above may be possible.

In FIG. 2, in contrast to FIG. 1, the patient 16 is assumed to be outside building 1. Between the third transmission and receiving station 17 on the one hand and three mobile radio base stations 8 through 10 closest to patient 16, there is a building-external radio communication 24 through 26. Just as for determination of the location of patient 16 inside building 1, there is also a triangulation performed by control unit 15 for the determination of the location of patient 16 outside building 1, but this is not based on the signal strength but rather on the signal travel time measured by the three mobile radio stations 8 through 10 of a location-relevant signal transmitted by mobile radio terminal 19 on the building-external radio communication 24 through 26.

The control unit 15 is conveniently located in central monitoring unit 13, such as by being integrated into it, and remote monitoring of location-relevant information occurs based on the signal strength measured by WLAN base stations 2 through 7 of the radio signal on the building-internal radio communication 21-23 or based on the signal travel times measured by the mobile radio base stations 8 through 10 of the radio signal on the building-external radio communication 24 through 26 to control unit 15. The remote transmission of location-relevant information from WLAN base stations 2 through 7 to control unit 15 can be performed, for example, through a power network of building 1. The previously mentioned triangulation of the location of the patient 16 can be performed by the control unit 15 depending on current information. A display of the current location is provided on monitor 14 of the central monitoring unit 13 shown in FIGS. 7 and 8 in an enlarged section.

FIG. 3 shows an enlarged representation of the third transmission and receiving station 17 with the WLAN terminal 18 having a first transmission and receiving antenna 27, with the mobile radio terminal 28 having a second transmission and receiving station 28, and with the RFID transponder 20. To enable medical monitoring of patient 16 regarding bodily condition, the patient 16 has at least one sensor 29 for the recording of medical patient data; in this exemplary embodiment the sensor 29 is integrated into the third transmission and receiving station 17 and allows skin contact with the patient 16 near the heart through two contact surfaces 30, 31 proceeding from the third transmission and receiving station 17, thus allowing recording of his or her heart rate.

Remote monitoring of patient 16 can be advantageously extended beyond mere determination of his or her current location simply by providing remote transmission of the patient data recorded by sensor 29 to central monitoring unit 13. If the patient data lies outside a data range medically plausible for the patient 16 and definable through the central monitoring unit 13, a warning signal can be shown on the monitor 14 of the central monitoring unit 13. This makes it possible, for instance, to send immediate medical assistance to the patient 16 if the warning signal is displayed. It is furthermore possible to output the warning signal in other ways, for instance acoustically.

Remote transmission of location-relevant information and/or patient data from the third transmission and receiving station 17 is particularly easy to perform through a mobile radio network to which the third transmission and receiving station 17 can establish a connection using the second transmission and receiving antenna 28.

Through sensor 29 for the recording of the heart rate of the patient 16, additional sensors, particularly located on the body of patient 16, can be provided for recording additional patient data, such as ECG data of the patient 16, blood pressure, breathing rate, and oxygen saturation. It is also possible to access additional stored information about the patient 16 through the central monitoring unit 13, such as demographical data and previous illnesses, and to display this patient data on the monitor 14 of the central monitoring unit 13.

The patient 16 can make contact in most locations with another, remotely located person when the third transmission and/or receiving station 17 additionally has the capacity for telephoning through the mobile radio network. This enables the patient 16 to make an emergency contact in an emergency situation, e.g. with a caregiver of the patient 16, and it is possible for the caregiver, when a warning signal is displayed on the central monitoring unit 13, to call the patient 16 through the mobile radio network in order to render assistance to the patient 16, e.g. in the form of instructions or to provide directions.

It is possible to fasten the third transmission and receiving station 17 to an arm band, a collar, or a belt of the patient 16, or to integrate it into a garment of patient 16. Furthermore, the third transmission and receiving station 17 can additionally have the functionality of a portable computer of the type commonly known as a “Personal Digital Assistant” or PDA.

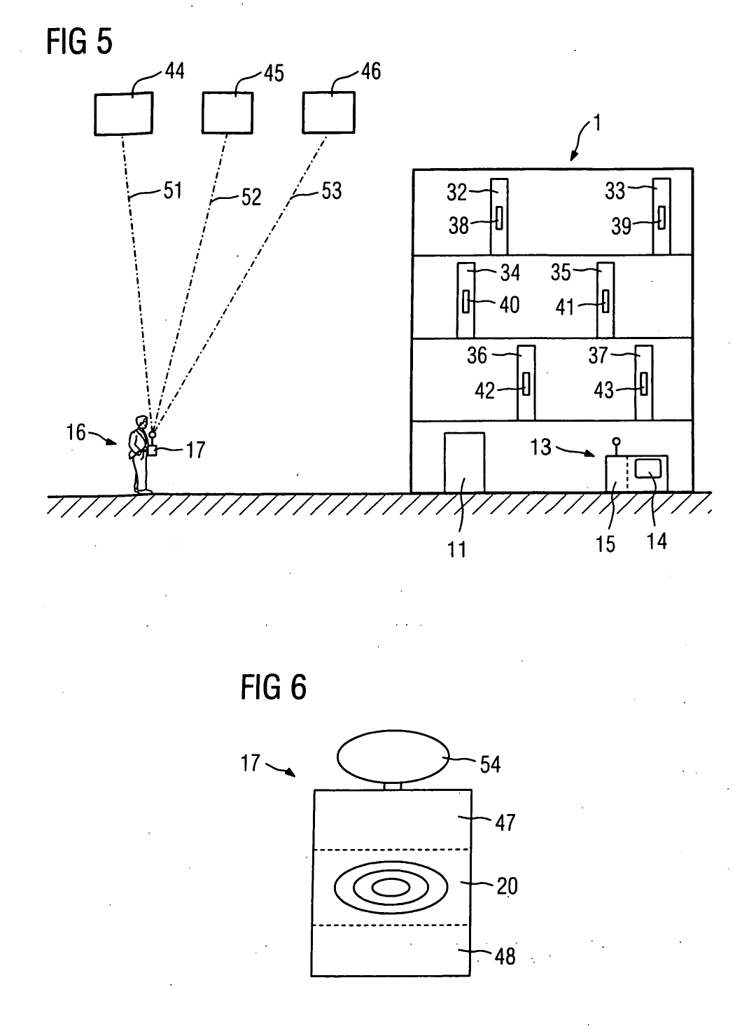

FIG. 4 and FIG. 5 each show a side view of building 1 with an entry area 11, first receiving stations distributed inside building 1 in the form of RFID reading units 38 through 43 integrated into door frames 32 through 37, second transmission stations distributed outside building 1 in the form of GPS satellites 44 through 46, the central monitoring unit 13 located in building 1 with a monitor 14 and with the integrated first control unit 15 and a patient 16 with an associated third transmission and receiving station 17 shown schematically simplified, which has a GPS receiver 47, the RFID transponder 20, and a second control unit 48. Des about the structure of the third transmission and receiving station 17 can be found in the enlarged representation thereof in FIG. 6.

In FIG. 4, the patient 16 is assumed to be inside building 1. Due to a movement of patient 16 in a direction of movement 49 through one of the door frames 32 through 37 shown in side view, RFID transponder 20 can be excited to transmission of a radio signal over a radio connection 50 with each door frame 32 through 37. This is shown in the drawing as an example using the door frame 36. In the radio signal, which can be received by the corresponding RFID reader 41, there is an identification code assigned to the patient 16 which can be transmitted from the RFID reader 42 to the first control unit 15 of the central monitoring unit 13. Based on this identification code in combination with the information as to which RFID reader 42 received this identification code, the control unit 15 can determine the current location of patient 16. The location can be given to the precise room due to the fact that the RFID reader 38 through 43 are installed in all door frames 32 through 37 which connect the rooms to one another. In additional, installation of additional RFID readers is possible inside the halls connecting rooms to one another. The location determined can be displayed on the monitor 14 of the central monitoring unit 13.

In FIG. 5, in contrast to FIG. 4, patient 16 is assumed to be outside building 1. From the three GPS satellites 44 through 46, a GPS radio signal can be transmitted through radio connections 51 through 53 with the GPS receiver 47 to GPS receiver 47 of the third transmission and receiving station 17. From each of the signal travel times of the radio signals, the location of the patient 16 can be determined according to the familiar GPS technology. Here it is advantageous to locate the second control unit 48 with patient 16 and to provide remote transmission of the location from the second control unit 48 to the central monitoring unit 13; as shown in FIG. 6, the second control unit 48 is conveniently integrated into the third transmission and receiving station 17. As already described in association with the example embodiment shown in FIGS. 1-3, remote transmission of the location is particularly easily achieved through the mobile radio network.

For a particularly flexible remote monitoring of patient 16, the central monitoring unit 13 is provided for a mobile transport; by transporting monitoring unit 13 from building 1 to a different building, not shown, it is possible, for instance, to monitor the patient 16 from the other building.

As an alternative to installation of the RFID readers 38 through 43 in door frames 32 through 37, it is possible to locate the RFID readers 38-43 in the floor or in the ceiling, whereby an assignment within a radio range of the RFID readers to the corresponding door frame 32 through 37 for the reliable detection of room changes on the part of patient 16 is convenient.

FIG. 6 shows an enlarged view of the third transmission and receiving station 17 with the GPS receiver 47 having a GPS receiver antenna 54, with the RFID transponder 20, and with the second control unit 48.

FIG. 7 and FIG. 8 show a monitor image displayed on the monitor 14 of the central monitoring unit 13 for display of the location of the patient 16 inside or outside building 1, respectively.

FIG. 7 shows a monitor image with a display of building 1 in a side view for display of the location of patient 16 in the building interior. On the monitor image, the ground floor and three upper floors of building 1 are shown in schematic representation, and the location of patient 16 on the second floor is denoted with a circular marking 55. The marking 55 changes its position in the building 1 depending on the currently determined location.

For particularly reliable remote monitoring of the location of patient 16, in the case of a location outside a definable location range 56, the display of a warning message through monitoring unit 13 and/or the third transmission and/or receiving station 17 is provided. In this embodiment, the location area 56 shown in a dashed line contour on the second and third floors is taken to be permissible. The warning message when the patient 16 leaves this location area 56 can, for instance, be achieved with a text message shown on the monitor 14 of the monitoring unit 13. Through the warning message, an assisting message is also possible for patient 16 on the third transmission and/or receiving station 17; the assisting message can inform the patient 16, for instance, how to return to the intended location area 56.

In an emergency situation, fast emergency assistance is possible due to the fact that upon a long-lasting continuance on the part of patient 16 in one location, suggesting an emergency situation, the display of a corresponding warning message is provided through the monitoring unit 13. In the case of detection of an emergency situation, both the continuance in a location and the location itself are best taken into consideration; for instance, although continuance for hours in a location which corresponds to the bed of the patient 16 does not indicate an emergency situation, in contrast a continuance of several hours in a location corresponding to a stairwell of building 1 urgently indicates an emergency situation. Just as for the warning message upon departure from the definable location area 56, the warning message upon continuance in one location can be displayed as a text message on the monitor 14. Moreover, the warning message can also be indicated with an acoustic alarm and flashing of the marking 55, which indicates the location of the patient 16.

FIG. 8 shows a monitor image with a map representation of a surrounding area of building 1 for display of the location of a patient 16 located in the vicinity outside of building 1. As in FIG. 7, the location area of the patient 16 is shown with a circular marking 55 and the definable location range 56 of the patient 16 is indicated with a dashed line contour on the monitor image. Moreover, streets 57 through 60 located in the vicinity of building 1 are shown on the monitor image. As for the departure from location range 56 inside building 1, departure from location range 56 outside of building 1 results in the display of a warning message.

Using a photo or video camera integrated into the third transmission and receiving station 17, it is possible to photograph or film, in addition to the location of the patient 16, also his surroundings or patient 16 himself. The image or film generated in this way can be transmitted to the central monitoring unit 13 and displayed on its monitor 14.

It is also possible to use the inventive system for monitoring children, prisoners in open detention centers, or persons requiring care.

In summary, for the simple and reliable radio-based remote monitoring of the location of a patient without limiting his or her freedom of movement, according to the invention there are two different locating technologies for the determination of the patient's location, inside and outside of the building. For this purpose, the system has first transmission and/or receiving units distributed inside the building, and second transmission and/or receiving units distributed outside the building, which at least temporarily establish a building-internal or building-external radio communication, respectively, with a third transmission and/or receiving unit. For determination of the location of the patient based on at least one location-relevant radio signal on each radio connection, there is a control unit, and for display of these determined locations there is a central monitoring unit.

Although modifications and changes may be suggested by those skilled in the art, it is the intention of the inventor to embody within the patent warranted hereon all changes and modifications as reasonably and properly come within the scope of his contribution to the art.

I claim as my invention:

1. A medical system for radio-based remote monitoring of a location of a patient relative to a building, said system comprising:
a plurality of first radio-based stations, selected from the group consisting of transmission stations and receiving stations, distributed inside said building, operating according to a first locating technology;
a plurality of second radio-based stations, selected from the group consisting of transmission stations and receiving stations, distributed outside of said building and operating according to a second locating technology different from said first locating technology;
a third radio-based station, selected from the group consisting of a transmission station and a receiving station, assigned to the patient that at least temporarily establishes a building-internal radio communication with at least one of said first stations and that at least temporarily establishes a building-external communication with at least one of said second stations, in order to produce at least one location-relevant radio signal via said building-internal radio communication or said building-external radio communication;
a control unit having access to said building-internal radio communication and said building-external radio communication that determines the location of the patient from said at least one location-relevant radio signal; and
a central monitoring unit in communication with said control unit that displays the location of the patient determined by the control unit.

2. A medical system as claimed in claim 1 wherein said plurality of first radio-based stations operate according to WLAN technology, and wherein each of said plurality of first radio-based stations comprises a WLAN base station, and wherein said third radio-based station comprises a WLAN terminal.

3. A medical system as claimed in claim 2 wherein at least three of said WLAN base stations detect a signal characteristic, selected from the group consisting of signal quality and signal strength, or at least one radio signal transmitted by said WLAN terminal, and wherein said control unit determines said location of the patient by triangulation from the signal characteristics respectively detected by said at least three WLAN base stations.

4. A medical system as claimed in claim 1 wherein said first plurality of radio-based stations operate according to RFID technology, and wherein each of said plurality of first radio-based stations comprises an RFID reader, and wherein said third radio-based station comprises an RFID transponder.

5. A medical system as claimed in claim 1 wherein said plurality of second radio-based stations operates according to digital mobile radio technology, and wherein each of said plurality of second radio-based stations comprises a mobile radio base station, and wherein said third radio-based station comprises a mobile radio terminal.

6. A medical system as claimed in claim 5 wherein at least three of said mobile radio base stations detects a signal travel time of a signal transmitted by said mobile radio terminal, and wherein said control unit determines the position of said patient by triangulation from the signal travel times respectively detected by said at least three mobile radio base stations.

7. A medical system as claimed in claim 1 wherein said plurality of second radio-based stations operate according to a GPS technology, and wherein each of said plurality of second radio-based stations comprises a GPS satellite, and wherein said third radio-based station comprises a GPS satellite receiver.

8. A medical system as claimed in claim 1 wherein said control unit is also assigned to the patient, and wherein said control unit wirelessly transmits a current location of the patient, as determined by said control unit, to said central monitoring unit.

9. A medical system as claimed in claim 1 wherein said control unit is disposed at said central monitoring unit and wherein said at least one location-relevant radio signal is wirelessly transmitted to said control unit by at least one of said plurality of first radio-based stations or at least one of said plurality of second radio-based stations.

10. A medical system as claimed in claim 1 wherein said control unit performs an initial attempt to determine the position of the patient from said building-internal radio communication, and performs a subsequent attempt to determine the position of the patient from said building-external radio communication only if said initial attempt is unsuccessful.

11. A medical system as claimed in claim 1 wherein said control unit comprises an automatic switchover between said building-internal radio communication and said building-external radio communication dependent on which of said building-internal radio communication and said building-external radio communication exhibits a higher signal characteristic, selected from the group consisting of signal quality and signal strength.

12. A medical system as claimed in claim 1 wherein said building comprises an entry area, and wherein said medical system comprises an RFID transponder assigned to the patient, and an RFID reader disposed at said entry area to interact with said RFID transponder to detect entry into and departure from the building by the patient, and wherein said control unit comprises an automatic switchover between said building-internal radio communication and said building-external radio communication dependent on receipt of a signal from said RFID transponder to said control unit.

13. A medical system as claimed in claim 1 wherein said control unit has a predetermined location range stored therein, and wherein said control unit causes a warning message to be emitted by at least one of said monitoring unit and said third radio-based station if the position of the patient determined by said control unit is outside of said predetermined location range.

14. A medical system as claimed in claim 1 wherein said control unit has a predetermined time duration stored therein, and wherein said control unit causes a warning message to be displayed at said monitoring unit if said control unit determines a continuous presence of the patient at one location that exceeds said predetermined time duration.

15. A medical system as claimed in claim 1 comprising at least one sensor assigned to the patient to record medical patient data from the patient.

16. A medical system as claimed in claim 15 comprising a signal transmitter assigned to the patient, in communication with said at least one sensor, that wirelessly transmits said medical patient data to said central monitoring unit, and wherein said central monitoring unit comprises a display at which said medical patient data are displayed.

17. A medical system as claimed in claim 16 wherein said central monitoring unit has at least one predetermined data range stored therein, and wherein said central monitoring unit causes a warning message to be displayed at said display if said medical patient data are outside of said predetermined data range.

18. A medical system as claimed in claim 15 wherein said signal transmitter is a mobile radio transmitter and transmits said medical patient data to said central monitoring unit via a mobile radio network.

19. A medical system as claimed in claim 1 wherein said third radio-based station comprises a mobile telephone base unit that automatically establishes a telephone communication to a predetermined telephone number dependent on the location of the patient.

20. A medical system as claimed in claim 1 wherein said central monitoring unit is a mobile unit.
